(19) United States
(12) Patent Application Publication
(10) Pub. No.: US 2014/0288234 A1
(43) Pub. Date: Sep. 25, 2014

(54) Optical Resin Material And Manufacturing Method Therefor

(71) Applicants: Yasuhiro Koike, Yokohama-city (JP); Akihiro Tagaya, Yokohama-city (JP)

(72) Inventors: Yasuhiro Koike, Yokohama-city (JP); Akihiro Tagaya, Yokohama-city (JP)

(21) Appl. No.: 14/237,290

(22) PCT Filed: Jul. 31, 2012
(86) PCT No.: PCT/JP2012/069507

§ 371 Date: May 7, 2014

(30) Foreign Application Priority Data
Aug. 5, 2011 (JP) 2011-172435

(51) Int. Cl. G02B 1/04

(52) U.S. Cl. CPC G02B 1/04; G02B 1/041
USPC 524/561; 526/326

(57) ABSTRACT

An optical resin material includes a multicomponent system whose number of components z which is defined under a counting condition of including original number x(x≧2) of copolymer into the number of components is three or more. Wherein the combination of the components constituting the multicomponent system is selected such that: at least one of respective signs of intrinsic orientational-birefringences of respective homopolymers which correspond to respective monomers constituting respective components of the copolymer and signs of orientational-birefringence properties which the low-molecular-weight organic compound presents in common in the respective homopolymers has a different sign from those of others, and also, at least one of photoelastic-birefringence properties of the respective homopolymers and photoelastic-birefringence properties which the low-molecular-weight organic compound presents in common in the respective homopolymers has a different sign from those of others.

### FIELD OF THE INVENTION

The present invention relates to an optical resin (optical polymer) whose orientational-birefringence and photoelastic-birefringence are both very small, and relates to an application of the same resin to an optical member (optical element, optical component or the like).

### BACKGROUND OF THE INVENTION

For materials constituting optical members having film-shapes, plate-shapes, lens-shapes or the like (for example, such as a film, a circuit board, a prism sheet and the like which are used in an LCD apparatus or such as a lens in a signal-reading lens system of an optical disk, a fresnel lens, a lenticular lens for a projection screen or the like) that are used in various kinds of optics-associated instruments, there are widely used light-transmissive resins and these are generally referred to as “optical resins” or “optical polymers”.

There exists birefringence property for one of important optical characteristics that must be taken into consideration in case of constituting an optical member by an optical resin. More specifically, an aspect that the optical resin possesses a large birefringence property is not preferable in many cases. In particular, in case of the use-applications exemplified above (in case of an LCD apparatus, an optical disk apparatus, a projection screen or the like), a bad influence is exerted to the image quality or the signal reading performance if there exists a film, a lens or the like having a birefringence property in the optical path and therefore, it is desired to use an optical member constituted by an optical resin in which the birefringence property thereof is restricted to be small as much as possible. In addition, it is needless to say that it is desirable for the birefringence property to be smaller also in case of a lens for camera, a spectacle lens or the like.

Meanwhile, as well known in this technical field, the birefringence presented by an optical polymer (hereinafter, abbreviated simply as “polymer” arbitrarily) has “orientational-birefringence” in which the main cause thereof lies in the orientation of the main-chain thereof and “photoelastic-birefringence” (usually, abbreviated as “photoelasticity”) which is caused by stress. The signs of the orientational-birefringence and the photoelasticity are derived from the chemical structure of the polymer and express properties which are inherent in each of the polymers.

More specifically, the orientational-birefringence is a birefringence generated generally by a phenomenon in which the main-chain of the chain-shaped polymer (polymer chain) is oriented and this main-chain orientation occurs in a process accompanied by a material flow such as, for example, extrusion and drawing processes when manufacturing a polymer film, injection-molding processes used frequently when manufacturing optical members having various kinds of shapes or the like in which the orientation remains by being fixed on the optical member.

On the other hand, the photoelastic-birefringence is a birefringence which is caused along with an elastic deformation (distortion) of the polymer. For an optical member using a polymer, caused by a volume shrinkage which occurs when, for example, it is cooled from the vicinity of the glass-transition temperature of the polymer thereof to a lower temperature compared with that, an elastic deformation (distortion) occurs and remains in the material, and this becomes a cause of the photoelastic-birefringence. In addition, for example, the material is deformed elastically caused also by an external force which the optical member receives in a state of being fixed on the instrument which is used under a normal temperature (glass-transition temperature or less) and this induces the photoelastic-birefringence.

Meanwhile, it is known that even if there exists an elastic deformation at the glass-transition temperature or less, the main-chain movement of a commonly-used optical polymer is frozen approximately and the orientation state itself of the main-chain is unchanged substantially. Therefore, it is conceivable, even if seeing from a microscopic point of view of the molecular level, that the photoelastic-birefringence is to be generated by a mechanism different from that of the aforementioned orientational-birefringence.

Both of the orientational-birefringence and the photoelastic-birefringence have signs and within the polymers, there exists a polymer in which the sign of the orientational-birefringence and the sign of the photoelastic-birefringence are opposite to each other (the sign of the orientational-birefringence is positive and the sign of the photoelastic-birefringence is negative, or the sign of the orientational-birefringence is negative and the sign of the photoelastic-birefringence is positive), and this is suggesting the difference between the generating mechanisms of the orientational-birefringence and the photoelastic-birefringence.

In this manner, the orientational-birefringence and the photoelastic-birefringence are birefringences generated by different mechanisms in which there exist various kinds of orientational-birefringences and photoelastic-birefringences presented by optical resins, but an optical resin which has both sufficiently small birefringences and which is suitable for the actual usage cannot not be found so much. For example, the resins such as polycarbonate, polystyrene and the like are excellent resins which are inexpensive and which have high transparencies and high refractive-indexes, but it becomes a drawback that both of the orientational-birefringence and the photoelastic-birefringence thereof show large values.

Speaking in principle, it becomes a situation in which the orientational-birefringence will not be generated if the orientation itself is made not to occur when manufacturing the optical member via a molding process of the optical resin. Actually, in case of molding various kinds of lenses, films and the like, the orientational-birefringence has been reduced by repressing the orientation of the polymer as much as possible depending on various kinds of ingenuities of molding methods. For example, for the injection-molding, there is employed a method of raising melting temperature of the polymer, a method of lengthening the time period for keeping comparatively high temperature in the inside of the die, or the like. In addition, for the production of the film, there has been employed a method in which the polymer is dissolved into a solvent, the obtained polymer solution is exposed on a base board, the solvent is dried and removed and so on (this method is referred to also as “solution casting film-forming method”). As just described, it is possible to repress the orientation of the polymer to some extent, but there sometimes occurs a case in which the production speed decreases compared with that in a producing method without repressing the orientation.

In addition, there has been employed an ingenuity which makes the photoelastic-birefringence not to be generated. For example, in case of producing an optical member from a molten state as in such a case of injection-molding, extrusion or the like, the cubic volume of the polymer constricts in a cooling process from the molten state to the room temperature, and distortion caused by stress will occur and therefore, the photoelastic-birefringence occurs. Therefore, for example, in case of various kinds of lenses or the like, there is added such a process in which after the molding, heat-treatment is applied from several hours to several tens of hours under a certain temperature and the distortion is to be removed or the like. The addition of such a process definitely decreases the production efficiency and also has a disadvantageous economically. In addition, even if the distortion has been removed, there cannot be eliminated such a defect that the photoelastic-birefringence will be generated if stress is added from the outside when used.

Also the technologies of reducing the birefringences of the optical resins by additions of additives have been studied and some of them were reported, but they all relate to the technologies for attempting to offset one of the orientational-birefringence or photoelastic-birefringence of the polymer which is formed as the base material depending on the orientational-birefringence property or the photoelastic-birefringence property of the opposite sign which the additive possesses and for attempting to make it become approximately zero. For the methods of offsetting the orientational-birefringence, there exist a method of copolymerizing monomers which present birefringence properties having positive and negative polarities respectively, a method of adding an organic compound having low molecular weight (low-molecular-weight organic compound) and the like. In addition, it was reported in academic papers that these methods are utilizable also for the offset of the photoelastic-birefringence.

However, in the above-mentioned two methods, it becomes a situation in which the added concentration of the low-molecular-weight organic compound or the copolymer composition of the copolymer for offsetting and eliminating the orientational-birefringence will have a value largely different from the value when offsetting and eliminating the photoelastic-birefringence, in which it was not possible to approximately eliminate both of them simultaneously.

When investigating specifically, first, there is described a “method of offsetting the birefringence property by copolymerization” in Non-patent Document 1 mentioned below. This method relates to a method of offsetting the birefringence property of the polymer chain by copolymerizing a monomer constituting homopolymer which presents positive orientational-birefringence (monomer having positive orientational-birefringence property) and a monomer constituting homopolymer which presents negative orientational-birefringence (monomer having negative orientational-birefringence property) randomly by a proper ratio. In this Non-patent Document 1, there are respectively selected benzyl methacrylate as the monomer having positive orientational-birefringence property and methyl methacrylate as the monomer having negative orientational-birefringence property and they are copolymerized randomly. Then, there is shown therein that the orientational-birefringence is approximately eliminated at the time when methyl methacrylate/benzyl methacrylate=82/18 by the weight ratio and the photoelastic-birefringence is approximately eliminated at the time when it is 92/8.

It should be noted, as described later, that with regard to a well-known infrared two-color method, in connection with the present invention, which is utilized for a measuring method of the degree of orientation of the main-chain of copolymer molecule or the main-chain of homopolymer, there is an explanation, for example, in Non-patent Document 3 mentioned below.

As mentioned above, different from the technology of approximately eliminating one of the orientational-birefringence and the photoelastic-birefringence depending on the additive to the light-transmissive polymer and the selection of the added concentration thereof or depending on the combination of the copolymerization and the selection of the composition ratio, there has not been proposed a proper technique for approximately eliminating both of the orientational-birefringence and the photoelastic-birefringence simultaneously yet. Therefore, in case of using optical resins for the constituent materials of various kinds of optical members (translucent sheet, lens, prism sheet and the like), it was not possible to avoid the defect, which is caused by either one of the birefringences, from appearing.

More specifically, in order to attempt to prevent the orientational-birefringence property from appearing depending on a process of drawing, extrusion, injection-molding or the like which is generally included in the manufacturing process of these optical members, when selecting the optimum added concentration or the copolymerization ratio for offsetting the “orientational-birefringence”, the diminishing of the photoelastic-birefringence property becomes insufficient and the photoelastic-birefringence appears caused by various kinds of external forces which are received in a state in which the optical member thereof is assembled. In addition, if selecting the added concentration or the copolymerization ratio which is suitable for diminishing the photoelastic-birefringence, the diminishing of the orientational-birefringence property becomes insufficient according to the above-mentioned process.

Therefore, there was proposed a technology which gets rid of the defect of the abovementioned technology and by which the orientational-birefringence property and the photoelastic-birefringence property of the optical resin material are diminished simultaneously and approximately eliminated (Patent Document 2). This technology is aiming to provide an optical resin material in which both of the orientational-birefringence property and the photoelastic-birefringence property are diminished and approximately eliminated, and to provide an optical member using that same material. Specifically, it is such as mentioned below.

This technology made it possible to solve the above-mentioned problem, with regard to an optical material having a multicomponent system of three or more components, which includes a copolymerization system of binary or higher system, by introducing a technique of selecting the combination and the component ratio (composition ratio) of the components of the multicomponent system thereof such that both of the orientational-birefringence property and the photoelastic-birefringence property will be canceled simultaneously with regard to the aforesaid optical material. Here, a portion of the multicomponent system may be an additive which does not constitute a copolymerization system (low-molecular-weight organic compound) and also may be a copolymerization system all together.

To be more concrete, the non-birefringent optical resin material relating to this technology includes a multicomponent system in which the number of components z, which is defined under a condition of counting the original number x(x≧2) of the copolymer by containing it in the number of components, is three or more, and the aforesaid multicomponent system is constituted only by a copolymer in which the original number x is three or more, or is constituted by a copolymer whose original number x is two or more and by a low-molecular-weight organic compound which has at least one kind of polarizability anisotropy and can be oriented in the polymer.

Here, the combination of the components constituting aforesaid multicomponent system is selected such that “at least one of respective signs of intrinsic orientational-birefringences of respective homopolymers which correspond to respective monomers constituting respective components of aforesaid copolymer and signs of orientational-birefringence properties which aforesaid low-molecular-weight organic compound presents in common in aforesaid respective homopolymers has a different sign from those of others, and also, at least one of photoelastic-birefringence properties of aforesaid respective homopolymers and photoelastic-birefringence properties which aforesaid low-molecular-weight organic compound presents in common in aforesaid respective homopolymers has a different sign from those of others”.

Then, component ratio of the components constituting aforesaid multicomponent system is selected such that “the orientational-birefringence and the photoelastic-birefringence which aforesaid non-birefringent optical resin presents will be canceled simultaneously by utilizing different-sign relation relating to aforesaid orientational-birefringence property and different-sign relation relating to aforesaid photoelastic-birefringence property”.

Typically, the absolute value of the intrinsic orientational-birefringence of the optical resin material is made to be 6.7×10⁻² or less, in which it is desirable for the same absolute value to be 6.7×10⁻³ or less and further, it is especially desirable for the same absolute value to be 3.3×10⁻³ or less. In addition, the absolute value of typical photoelastic coefficient is 50.0[TPa⁻¹] or less, in which it is desirable for the same absolute value to be 5.0[TPa⁻¹] or less and further, it is especially desirable for the same absolute value to be 1.0[TPa⁻¹] or less.

Then, for the low-molecular-weight organic compound, there is selected an organic compound whose molecular weight is 2000 or less, desirably, 1500 or less and which has polarizability anisotropy and can be oriented in the polymer.

It should be noted that the “intrinsic orientational-birefringence” is an index indicating easiness in occurrence of the orientational-birefringence for every optical resin material and is an index which can be defined for the optical resin material having a base material of either one of homopolymer and copolymer, so that supposing that the orientational-birefringence is Δn and the degree of orientation is f, the inherent birefringence Δn0 satisfies the following equations.

Δn=f×Δn0 (a)

or

Δn0=Δn/f (b)

Here, the degree of orientation f is an index indicating the degree of the orientation of the polymer main-chain and a state in which the polymer is oriented perfectly toward one direction is indicated as f=1. The size (with ±sign) of the orientational-birefringence at that time corresponds to the inherent birefringence Δn0.

However, there cannot be obtained the state in which f=1 is actually satisfied, so that in order to comprehend the inherent birefringence Δn0 actually, it becomes a situation in which it is enough if substituting a value of birefringence Δn which is measured by proper (single or plural) value(s) for f<1 into the above-mentioned (a) or (b). As shown by an example described later, one example of a suitable value of f is f=0.03 and when using this value, the following equation can be obtained.

Δn0=Δn/0.03 (c)

The condition referred to as “the absolute value of the intrinsic orientational-birefringence of the optical resin material is 6.7×10⁻² or less” mentioned above can be rephrased as “the birefringence size appearing under a condition of the degree of orientation f=0.03 is approximately 2×10⁻² or less”.

Next, it will be assumed that the optical member relating to this technology is made to be a sheet-shaped or lens-shaped optical member obtained by molding these optical resins. For the molding, there exists extrusion, drawing, injection-molding or the like. The optical member relating to this technology is constituted by a resin which scarcely generates the orientational-birefringence and the photoelastic-birefringence, and therefore, the orientational-birefringence caused by the molding process thereof does not occur and also, even if there exists an elastic deformation, the photoelastic-birefringence will scarcely appear.

According to this technology, it is possible to diminish the orientational-birefringence property and the photoelastic-birefringence property of the optical resin material simultaneously and to eliminate them approximately. In addition, by using an optical resin material whose orientational-birefringence property and photoelastic-birefringence property are diminished simultaneously and approximately eliminated as the constituent material of the optical member, it is possible to provide an optical member in which the orientational-birefringence is scarcely presented even if there is included such a process, in the manufacturing process, in which the orientation of the polymer main-chain such as extrusion, drawing, injection-molding or the like will occur and also, in which the photoelastic-birefringence scarcely appears even if there is an elastic deformation caused by an external force or the like.

Further, the optical resin relating to this technology never disturbs the optical path or the polarization state by the orientational-birefringence or the photoelastic-birefringence even if it becomes a state in which an adhesive or pressure-sensitive adhesive agent for optical use exists in the optical path caused by using this optical resin as a constituent component of the adhesive or pressure-sensitive adhesive agent for optical use (for example, in case of bonding lenses together by an adhesive agent for optical use).

Next, this technology described in the Patent Document 2 will be reviewed. For example, as one of the illustrative embodiments of this technology, there is described “poly(MMA/3FMA/BzMA=55.5/38.0/6.5(wt)/(wt)/(wt))”. With regard to the poly(MMA/3FMA/BzMA=55.5/38.0/6.5(wt)/(wt)/(wt)), the glass-transition temperature is around 95° C. and the heat resistance thereof is not enough for the use-application of such as an optical film for liquid crystal display, a pickup lens and the like in which the glass-transition temperature of around 120° C. is generally required. For these use-applications and for a use-application in which a higher heat resistance is required similarly, it is necessary to provide a concrete optical resin material which can respond to that request, but it is difficult to respond to the request thereof in this technology.

In addition, in order to be used in these use-applications actually and to become popular, also with regard to the matters of the mechanical characteristic (strength with respect to the bending or the like), the cost and the like, they must lie within the acceptable degree, but the abovementioned technology has a difficulty also about these matters.
*Non-patent Document 1: Shuichi Iwata, Hisashi Tsukahara, Eisuke Nihei, and Yasuhiro Koike, Applied Optics, vol. 36, pp. 4549-4555 (1997)
*Patent Document 1: Japanese unexamined patent publication No. H8-110402
*Non-patent Document 2: H. Ohkita, K. Ishibashi, D. Tsurumoto, A. Tagaya, and Y. Koike, Applied Physics A, published online on Dec. 21, 2004.
*Non-patent Document 3: Akihiro Tagaya, Shuichi Iwata, Eriko Kawanami, Hisashi Tsukahara, and Yasuhiro Koike, Jpn. J. Appl. Phys. vol. 40, pp. 6117-6123 (2001)
*Patent Document 2: Japanese unexamined patent publication No. 2006-308682

### SUMMARY OF THE INVENTION

The present invention was invented in view of the abovementioned background technology and has an object to provide an optical resin material or the like which is excellent in heat resistance.

According to the present invention, in order to achieve the abovementioned object, there are employed constitutions just described in the scope of claim. Hereinafter, there will be explained the present invention in detail.

A first aspect of the present invention lies in an optical resin material including a multicomponent system whose number of components z which is defined under a counting condition of including original number x(x≧2) of copolymer into the number of components is three or more, wherein aforesaid multicomponent system is constituted only by a copolymer whose original number x is three or more, or is constituted by a copolymer whose original number x is two or more and by at least one kind of low-molecular-weight organic compound which has polarizability anisotropy and which can be oriented in polymer; the combination of the components constituting aforesaid multicomponent system is selected such that: at least one of respective signs of intrinsic orientational-birefringences of respective homopolymers which correspond to respective monomers constituting respective components of aforesaid copolymer and signs of orientational-birefringence properties which aforesaid low-molecular-weight organic compound presents in common in aforesaid respective homopolymers has a different sign from those of others, and also, at least one of photoelastic-birefringence properties of aforesaid respective homopolymers and photoelastic-birefringence properties which aforesaid low-molecular-weight organic compound presents in common in aforesaid respective homopolymers has a different sign from those of others; component ratio of the components constituting aforesaid multicomponent system is selected such that the orientational-birefringence and the photoelastic-birefringence which aforesaid non-birefringent optical resin presents will be canceled simultaneously by utilizing different-sign relation relating to aforesaid orientational-birefringence property and different-sign relation relating to aforesaid photoelastic-birefringence property; and at least one of the monomers constituting the components of aforesaid copolymer is tert-butyl methacrylate.

According to this constitution, there can be obtained an optical resin material which is excellent in heat resistance. In particular, in a case in which there is contained, as an essential component, tert-butyl methacrylate in which the glass-transition temperature as a homopolymer indicates 110° C. or more and which does not include halogen atom, there can be obtained an optical resin material whose heat resistance is high, which presents a low birefringence and which is very important industrially.

A second aspect of the present invention lies in an optical resin material including a multicomponent system whose number of components z which is defined under a counting condition of including original number x(x≧2) of copolymer into the number of components is three or more, wherein aforesaid multicomponent system is constituted only by a copolymer whose original number x is three or more, or is constituted by a copolymer whose original number x is two or more and by at least one kind of low-molecular-weight organic compound which has polarizability anisotropy and which can be oriented in polymer; the combination of the components constituting aforesaid multicomponent system is selected such that: at least one of respective signs of intrinsic orientational-birefringences of respective homopolymers which correspond to respective monomers constituting respective components of aforesaid copolymer and signs of orientational-birefringence properties which aforesaid low-molecular-weight organic compound presents in common in aforesaid respective homopolymers has a different sign from those of others, and also, at least one of photoelastic-birefringence properties of aforesaid respective homopolymers and photoelastic-birefringence properties which aforesaid low-molecular-weight organic compound presents in common in aforesaid respective homopolymers has a different sign from those of others; component ratio of the components constituting aforesaid multicomponent system is selected such that the orientational-birefringence and the photoelastic-birefringence which aforesaid non-birefringent optical resin presents will be canceled simultaneously by utilizing different-sign relation relating to aforesaid orientational-birefringence property and different-sign relation relating to aforesaid photoelastic-birefringence property; and at least two of the monomers constituting the components of aforesaid copolymer are methyl methacrylate and tert-butyl methacrylate.

According to this constitution, there can be obtained an optical resin material which is excellent in heat resistance.

A third aspect of the present invention lies in an optical resin material including a multicomponent system whose number of components z which is defined under a counting condition of including original number x(x≧2) of copolymer into the number of components is three or more, wherein aforesaid multicomponent system is constituted only by a copolymer whose original number x is three or more, or is constituted by a copolymer whose original number x is two or more and by at least one kind of low-molecular-weight organic compound which has polarizability anisotropy and which can be oriented in polymer; the combination of the components constituting aforesaid multicomponent system is selected such that: at least one of respective signs of intrinsic orientational-birefringences of respective homopolymers which correspond to respective monomers constituting respective components of aforesaid copolymer and signs of orientational-birefringence properties which aforesaid low-molecular-weight organic compound presents in common in aforesaid respective homopolymers has a different sign from those of others, and also, at least one of photoelastic-birefringence properties of aforesaid respective homopolymers and photoelastic-birefringence properties which aforesaid low-molecular-weight organic compound presents in common in aforesaid respective homopolymers has a different sign from those of others; component ratio of the components constituting aforesaid multicomponent system is selected such that the orientational-birefringence and the photoelastic-birefringence which aforesaid non-birefringent optical resin presents will be canceled simultaneously by utilizing different-sign relation relating to aforesaid orientational-birefringence property and different-sign relation relating to aforesaid photoelastic-birefringence property; and at least three of the monomers constituting the components of aforesaid copolymer are methyl methacrylate, tert-butyl methacrylate and benzyl methacrylate.

According to this constitution, there can be obtained an optical resin material which is excellent in heat resistance.

A fourth aspect of the present invention lies in the optical resin material as described above, wherein the inherent birefringence is within the range of −3.0×10⁻³ or more and 2.4×10⁻³ or less; the photoelastic coefficient is within the range of −3.3 [TPa⁻¹] or more and 5.0 [TPa⁻¹] or less; and the following simultaneous equations (B) to (D) are satisfied in which there exists a composition for each component that becomes positive (solution of the simultaneous equations):

$$\begin{matrix}\begin{matrix}Δ {n}^{0} = Δ {n}_{PMMA}^{0} \times α + Δ {n}_{PtBMA}^{0} \times β + Δ {n}_{PBzMA \times γ}^{0} \\ = - 5.6 \times α + 1.45 \times β + 19.5 \times γ\end{matrix} & ( B ) \\ \begin{matrix}C = {C}_{PMMA} \times α + {C}_{PtBMA} \times β + {C}_{PBzMA} \times γ \\ = - 5.5 \times α - 2.97 \times β + 48.4 \times γ\end{matrix} & ( C ) \\ α + β + γ = 100 & ( D )\end{matrix}$$

(Here, Δn⁰_{PMMA}, Δn⁰_{PtBMA}, Δn⁰_{PBzMA} and C_{PMMA}, C_{PtBMA}, C_{PBzMA} express inherent birefringences [×10⁻³] and photoelastic coefficients [TPa⁻¹] of PMMA, PtBMA, PBzMA respectively, and α, β, γ express weight ratios (%) of methyl methacrylate component, tert-butyl methacrylate component, benzyl methacrylate component in the copolymer respectively.)

According to this constitution, there can be obtained an optical resin material which is excellent in heat resistance.

A fifth aspect of the present invention lies in the optical resin material as described above, wherein α=40 (wt %), β=52 (wt %) and γ=8 (wt %) are satisfied.

According to this constitution, there can be obtained an optical resin material which is excellent in heat resistance.

A sixth aspect of the present invention lies in the optical resin material as described above, wherein at least one component within the components constituting aforesaid multicomponent system is at least one of subcomponent and additive.

A seventh aspect of the present invention lies in a manufacturing method of an optical resin material for manufacturing an optical resin material by copolymerization in which aforesaid optical resin material is an optical resin material including a multicomponent system whose number of components z which is defined under a counting condition of including original number x(x≧2) of copolymer into the number of components is three or more, wherein aforesaid multicomponent system is constituted only by a copolymer whose original number x is three or more, or is constituted by a copolymer whose original number x is two or more and by at least one kind of low-molecular-weight organic compound which has polarizability anisotropy and which can be oriented in polymer; the combination of the components constituting aforesaid multicomponent system is selected such that: at least one of respective signs of intrinsic orientational-birefringences of respective homopolymers which correspond to respective monomers constituting respective components of aforesaid copolymer and signs of orientational-birefringence properties which aforesaid low-molecular-weight organic compound presents in common in aforesaid respective homopolymers has a different sign from those of others, and also, at least one of photoelastic-birefringence properties of aforesaid respective homopolymers and photoelastic-birefringence properties which aforesaid low-molecular-weight organic compound presents in common in aforesaid respective homopolymers has a different sign from those of others; component ratio of the components constituting aforesaid multicomponent system is selected such that the orientational-birefringence and the photoelastic-birefringence which aforesaid non-birefringent optical resin presents will be canceled simultaneously by utilizing different-sign relation relating to aforesaid orientational-birefringence property and different-sign relation relating to aforesaid photoelastic-birefringence property; and at least one of the monomers constituting the components of aforesaid copolymer is tert-butyl methacrylate.

According to this constitution, there can be obtained an optical resin material which is excellent in heat resistance.

An eighth aspect of the present invention lies in a manufacturing method of an optical film for film-forming an optical resin material by a solution casting film-forming method which includes a manufacturing process of an optical resin material for manufacturing an optical resin material by copolymerization in which aforesaid optical resin material is an optical resin material including a multicomponent system whose number of components z which is defined under a counting condition of including original number x(x≧2) of copolymer into the number of components is three or more, wherein
aforesaid multicomponent system is constituted only by a copolymer whose original number x is three or more, or is constituted by a copolymer whose original number x is two or more and by at least one kind of low-molecular-weight organic compound which has polarizability anisotropy and which can be oriented in polymer;
the combination of the components constituting aforesaid multicomponent system is selected such that:
at least one of respective signs of intrinsic orientational-birefringences of respective homopolymers which correspond to respective monomers constituting respective components of aforesaid copolymer and signs of orientational-birefringence properties which aforesaid low-molecular-weight organic compound presents in common in aforesaid respective homopolymers has a different sign from those of others, and also, at least one of photoelastic-birefringence properties of aforesaid respective homopolymers and photoelastic-birefringence properties which aforesaid low-molecular-weight organic compound presents in common in aforesaid respective homopolymers has a different sign from those of others;
component ratio of the components constituting aforesaid multicomponent system is selected such that the orientational-birefringence and the photoelastic-birefringence which aforesaid non-birefringent optical resin presents will be canceled simultaneously by utilizing different-sign relation relating to aforesaid orientational-birefringence property and different-sign relation relating to aforesaid photoelastic-birefringence property; and
at least one of the monomers constituting the components of aforesaid copolymer is tert-butyl methacrylate.

According to this constitution, there can be obtained an optical film which is excellent in heat resistance.

A ninth aspect of the present invention lies in an optical film for display, which is obtained by molding an optical resin material, wherein aforesaid optical resin material is the optical resin material as described above.

A tenth aspect of the present invention lies in an optical film for liquid crystal display, which is obtained by molding an optical resin material, wherein aforesaid optical resin material is the optical resin material as described above.

An eleventh aspect of the present invention lies in a polarizer protective film, which is obtained by molding an optical resin material, wherein aforesaid optical resin material is the optical resin material as described above.

A twelfth aspect of the present invention lies in an optical film, which is obtained by molding an optical resin material by a solution casting film-forming method wherein aforesaid optical resin material is the optical resin material as described above.

A thirteenth aspect of the present invention lies in a polarization-plane light-source apparatus, which is obtained by molding an optical resin material, wherein aforesaid optical resin material is the optical resin material as described above.

A fourteenth aspect of the present invention lies in a lens, which is obtained by molding an optical resin material, wherein aforesaid optical resin material is the optical resin material as described above.

A fifteenth aspect of the present invention lies in a screen whose raw material is an optical resin material, wherein aforesaid optical resin material is the optical resin material as described above.

A sixteenth aspect of the present invention lies in an optical element, which is obtained by molding an optical resin material, wherein aforesaid optical resin material is the optical resin material as described above.

A seventeenth aspect of the present invention lies in a member dispose in an optical path, which is obtained by molding an optical resin material, wherein aforesaid optical resin material is the optical resin material as described above.

An eighteenth aspect of the present invention lies in the optical resin material according to claim 3, wherein the inherent birefringence is within the range of −3.0×10⁻³ or more and 2.4×10⁻³ or less; the photoelastic coefficient is within the range of −3.3 [TPa⁻¹] or more and 5.0 [TPa⁻¹] or less; and the following simultaneous equations (BB) to (DD) are satisfied in which there exists a composition for each component that becomes positive (solution of the simultaneous equations):

$$\begin{matrix}\begin{matrix}Δ {n}^{0} = Δ {n}_{PMMA}^{0} \times {α}_{1} + Δ {n}_{PtBMA}^{0} \times {α}_{2} + Δ {n}_{PBzMA}^{0} \times \\ {α}_{3} + Δ {n}_{4}^{0} \times {α}_{4} + … + Δ {n}_{n}^{0} \times {α}_{n} \\ = - 5.6 \times {α}_{1} + 1.45 \times {α}_{2} + 19.5 \times {α}_{3} + Δ {n}_{4}^{0} \times \\ {α}_{4} + … + Δ {n}_{n}^{0} \times {α}_{n}\end{matrix} & ( BB ) \\ \begin{matrix}C = {C}_{PMMA} \times {α}_{1} + {C}_{PtBMA} \times {α}_{2} + {C}_{PBzMA} \times \\ {α}_{3} + {C}_{4} \times {α}_{4} + … + {C}_{n} \times {α}_{n} \\ = - 5.5 \times {α}_{1} - 2.91 \times {α}_{2} + 48.4 \times {α}_{3} + {C}_{4} \times {α}_{4} + … + \\ {C}_{n} \times {α}_{n}\end{matrix} & ( CC ) \\ {α}_{1} + {α}_{2} + {α}_{3} + {α}_{4} + … + {α}_{n} = 100 & ( DD )\end{matrix}$$

(Here, Δn⁰_{PMMA}, Δn⁰_{PtBMA}, Δn⁰_{PBzMA}, Δn⁰₄, Δn⁰ₙ, C_{PMMA}, C_{PtBMA}, C_{PBzMA}, C₄, Cₙ express inherent birefringences [×10⁻³] and photoelastic coefficients [TPa⁻¹] of PMMA, PtBMA, PBzMA, the fourth component, the n^{th} component respectively, and α₁, α₂, α₃, α₄, αₙ express weight ratios (%) of methyl methacrylate component, tert-butyl methacrylate component, benzyl methacrylate component, the fourth component, the n^{th} component in the copolymer respectively.)

According to this constitution, there can be obtained an optical resin material which is excellent in heat resistance.

It should be noted that, for example, the following constitutions may be employed without employing the above-mentioned constitutions. An optical film for display, which is obtained by molding an optical resin material, in which the aforesaid optical resin material is the optical resin material as described above.

An optical film for liquid crystal display, which is obtained by molding an optical resin material, in which the aforesaid optical resin material is the optical resin material described in any one of claims 2 to 6 or in claim 16. A polarizer protective film, which is obtained by molding an optical resin material, in which the aforesaid optical resin material is the optical resin material as described above.

A polarization-plane light-source apparatus, which is obtained by molding an optical resin material, in which the aforesaid optical resin material is the optical resin material as described above.

A lens, which is obtained by molding an optical resin material, in which the aforesaid optical resin material is the optical resin material as described above. A screen, which is obtained by molding an optical resin material, in which the aforesaid optical resin material is the optical resin material as described above.

An optical element, which is obtained by molding an optical resin material, in which the aforesaid optical resin material is the optical resin material as described above.

A member dispose in an optical path, which is obtained by molding an optical resin material, in which the aforesaid optical resin material is the optical resin material as described above.

According to the present invention, there can be obtained an optical resin material or the like which is excellent in heat resistance.

Still other objects, features or advantages of the present invention will become clear by detailed explanations based on the exemplified embodiments of the present invention described later and based on the attached drawings.

### BRIEF DESCRIPTION OF THE DRAWINGS

FIG. 1 is a drawing showing a constitution of a general liquid crystal display.

FIG. 2 is a chart showing orientational-birefringence vs orientation-degree of polymer main-chain of a copolymer poly(MMA/tBMA/BzMA=40/52/8(wt/wt/wt)).

### DETAILED DESCRIPTION OF THE INVENTION

Hereinafter, there will be explained exemplified embodiments of the present invention in detail with reference to the drawings.

In case of classifying the signs of the orientational-birefringence and the photoelastic-birefringence of the homopolymers corresponding to the respective monomers which constitute a copolymer of this exemplified embodiment in accordance with (orientational-birefringence/photoelasticity), the following items can be provided for the monomer units which are preferably used in this exemplified embodiment.

*Benzyl methacrylate or cyclohexylmaleimide for the monomer unit which satisfies “positive/positive”;

*Styrene, cyclohexyl methacrylate or dicyclopentanyl methacrylate for the monomer unit which satisfies “negative/positive”;

*Tert-butyl methacrylate for the monomer unit which satisfies “positive/negative”;

*Methyl methacrylate, ethyl methacrylate or isobutyl methacrylate for the monomer unit which satisfies “negative/negative”

It should be noted, within the above-mentioned monomer units, that the tert-butyl methacrylate is contained as an essential component. In addition, it is allowed to select a copolymerizable monomer unit other than those mentioned above.

In this exemplified embodiment, a low-birefringence copolymer or the like which is composed of MMA(Methyl Methacrylate), tBMA(tert-Butyl Methacrylate) and BzMA(Benzyl Methacrylate) is dealt with. From the numerical values of the inherent birefringences and the photoelastic-birefringences corresponding to the respective homopolymers PMMA, PtBMA and PBzMA, it is possible to find a copolymer composition in which both of the orientational-birefringence and the photoelastic-birefringence become very low. That is a material in which centering on the poly(MMA/tBMA/BzMA=40/52/8(wt/wt/wt)), the inherent birefringence is within the range of −3.0×10⁻³ or more to 2.4×10⁻³ or less, the photoelastic coefficient is within the range of −3.3 [TPa⁻¹] or more to 5.0 [TPa⁻¹] or less, and the simultaneous equations (B) to (D) are satisfied in which there exists a composition for each component that becomes positive (solution of the simultaneous equations). It is desirable for the range of the inherent birefringence to be −2.5×10⁻³ or more to 2.0×10⁻³ or less and it is still more desirable to be −1.4×10⁻³ or more to 1.4×10⁻³ or less. It is desirable for the range of the photoelastic coefficient to be −2.5 [TPa⁻¹] or more to 2.5 [TPa⁻¹] or less and it is still more desirable to be −1.5 [TPa⁻¹] or more to 1.5 [TPa⁻¹] or less. By the simultaneous equations (B) to (D) (described again hereinafter), it is possible to confirm whether or not the composition lies within this range.

$$\begin{matrix}\begin{matrix}Δ {n}^{0} = Δ {n}_{PMMA}^{0} \times α + Δ {n}_{PtBMA}^{0} \times β + Δ {n}_{PBzMA}^{0} \times γ \\ = - 5.6 \times α + 1.45 \times β + 19.5 \times γ\end{matrix} & ( B ) \\ \begin{matrix}C = {C}_{PMMA} \times α + {C}_{PtBMA} \times β + {C}_{PBzMA} \times γ \\ = - 5.5 \times α - 2.91 \times β + 48.4 \times γ\end{matrix} & ( C ) \\ α + β + γ = 100 & ( D )\end{matrix}$$

The composition ratios of MMA, tBMA and BzMA in the above-mentioned copolymer are denoted so as to obtain 100% depending only on these components. It is possible to use a polymerization initiator and a chain-transfer agent which are used in the polymerization of a general polymer for the synthesis of the optical resin material provided by this exemplified embodiment, and it is allowed for the components, which are derived from those above after the reaction, to remain in the aforesaid resin material. Generally, these components are components of very small amounts, so that it is not necessary to take these components into consideration in particular for the aforementioned design from a view point of the birefringence property of the optical resin material. Therefore, by selecting these polymerization initiator and chain-transfer agent and by adjusting the added concentration thereof, it is possible to arbitrarily adjust the average molecular weight & molecular weight distribution of the optical resin material which is to be synthesized.

Also, it is allowed to add additives such as antioxidant agents and the like, which are used for a general resin, to the optical resin material.

The amounts of these agents are generally very small, so that the influence to the birefringence is small and it is not necessary to take these agents into consideration in particular for the aforementioned design from a view point of the birefringence property of the optical resin material.

In the aforementioned simultaneous equations, the conditions thereof are presented from a view point of the birefringence property for the composition ratio of the copolymer which is composed of MMA, tBMA and BzMA. It is allowed to add a little amount of other components to the copolymer having the composition, which satisfies those equations, for the copolymerization thereof.

In Table 2, there are charted concrete copolymerization examples (copolymer compositions and birefringence properties (calculated values)).

TABLE 2

| | | Inherent | Photoelastic |
|---|---|---|---|
| | | birefringence | coefficient |
| No. | Copolymer | [×10⁻³] | [Tpa⁻¹] |
| 1 | poly(MMA/tBMA/BzMA = 40/52/8(wt/wt/wt)) | 0.0 | 0.0 |
| 2 | poly(MMA/tBMA/BzMA = 89/1/10(wt/wt/wt)) | −3.0 | 0.0 |
| 3 | poly(MMA/tBMA/BzMA = 81/9/10(wt/wt/wt)) | −2.5 | 0.0 |
| 4 | poly(MMA/tBMA/BzMA = 63/28/9(wt/wt/wt)) | −1.4 | 0.0 |
| 5 | poly(MMA/tBMA/BzMA = 18/75/7(wt/wt/wt)) | 1.4 | 0.0 |
| 6 | poly(MMA/tBMA/BzMA = 9/85/6(wt/wt/wt)) | 2.0 | 0.0 |
| 7 | poly(MMA/tBMA/BzMA = 2/92/6(wt/wt/wt)) | 2.4 | 0.0 |
| 8 | poly(MMA/tBMA/BzMA = 22/78/1(wt/wt/wt)) | 0.0 | −3.3 |
| 9 | poly(MMA/tBMA/BzMA = 26/71/2(wt/wt/wt)) | 0.0 | −2.5 |
| 10 | poly(MMA/tBMA/BzMA = 32/63/5(wt/wt/wt)) | 0.0 | −1.5 |
| 11 | poly(MMA/tBMA/BzMA = 49/40/11(wt/wt/wt)) | 0.0 | 1.5 |
| 12 | poly(MMA/tBMA/BzMA = 55/32/13(wt/wt/wt)) | 0.0 | 2.5 |
| 13 | poly(MMA/tBMA/BzMA = 55/32/13(wt/wt/wt)) | 0.0 | 5.0 |

The copolymers described in Table 2 are excellent polymers in which any one of the birefringence properties is low compared with that of PMMA. The copolymer, in which both of the inherent birefringence and the photoelastic coefficient are approximately zero, has the lowest birefringence property and it is essentially difficult for the birefringence thereof to occur also under various kinds of molding conditions, and further, the birefringence which is generated when being used for the polymer member or the like is also very low, and therefore, it is needless to say that the copolymer is the most excellent copolymer. However, with regard to the copolymer in which the above-mentioned photoelastic coefficient is approximately zero, the absolute value of the inherent birefringence thereof is smaller than that of PMMA, so that if forming the copolymer under the condition in which it is comparatively difficult for the polymer molecular chain to be oriented, the low-birefringence polymer member or the like can be obtained easily, and further, it is difficult for the birefringence to be generated also when being used for the polymer member or the like, and therefore, the copolymer is an excellent copolymer. In addition, with regard to the above-mentioned copolymer in which the inherent birefringence is approximately zero, the absolute value of the photoelastic coefficient thereof is smaller than that of PMMA, and therefore, the low-birefringence polymer member can be obtained easily also in a high-speed molding, and also, the copolymer is an excellent copolymer whose birefringence, generated when being used, is also comparatively small.

The above description relates to representative examples of copolymers having low-birefringence properties, but it is not to be limited by these examples.

It is allowed, if necessary, to add a little amount of other component (subcomponent). In a case in which the weight of the components (MMA, tBMA, BzMA) of the copolymer, which is adjusted so as to satisfy the aforementioned condition, is made to be 100, it is desirable for the other component to be 16 or less, it is more desirable to be 8 or less and it is still more desirable to be 5 or less. It is allowed for the other component to be formed by one kind of component or to be formed by plural kinds of components. In case of selecting a monomer for the other component, it is allowed for the monomer to be copolymerized together with MMA, tBMA and BzMA. In case of carrying out copolymerization, the copolymerization is together with MMA, the inherent birefringence property and the photoelastic coefficient of the component thereof are found experimentally, and the number of components which are necessary in the simultaneous equations for calculating the composition ratio is added together, in which by solving those equations, it is possible to find desirable composition ratios.

When the simultaneous equations (B) to (D) of the copolymer composed of MMA, tBMA and BzMA are extended to a case in which the total number of components, in which MMA, tBMA, BzMA and the added components are all added together, is “n”, there can be obtained simultaneous equations (BB) to (DD). Actually, it is enough if solving these equations. Since the number of the equations is three, it is not possible to obtain solutions analytically if the number of undetermined coefficients becomes 4 or more. However, by setting the composition ratios for some components, it is possible, if using a computer or the like, to obtain the solutions which satisfy the simultaneous equations numerically. Similarly as in the abovementioned case, that is a material in which centering on the poly(MMA/tBMA/BzMA=40/52/8(wt/wt/wt)), the inherent birefringence is within the range of −3.0×10⁻³ or more to 2.4×10⁻³ or less, and the photoelastic coefficient is within the range of −3.3 [TPa⁻¹] or more to 5.0 [TPa⁻¹] or less, and the simultaneous equations (BB) to (DD) are satisfied in which there exists a composition for each component that becomes positive (solution of the simultaneous equations). It is desirable for the range of the inherent birefringence to be −2.5×10⁻³ or more to 2.0×10⁻³ or less and it is still more desirable to be −1.4×10⁻³ or more to 1.4×10⁻³ or less. It is desirable for the range of the photoelastic coefficient to be −2.5 [TPa⁻¹] or more to 2.5 [TPa⁻¹] or less and it is still more desirable to be −1.5 [TPa⁻¹] or more to 1.5 [TPa⁻¹] or less. By the simultaneous equations (BB) to (DD), it is possible to confirm whether or not the composition lies within this range.

Δn⁰=Δn_{PMMA}⁰×α₁+Δn_{PtBMA}×α₂+Δn_{PBzMA}×α₃+Δn₄⁰×α₄+···+Δnₙ⁰×αₙ=−5.6×α₁+1.45×α₂+19.5×α₃+Δn₄⁰×α₄+··+Δn_{N}⁰×αₙ (BB)

C=C_{PMMA}×α₁+C_{PtBMA}×α₂+C_{PBzMA}×α₃+C₄×+···+Cₙ×αₙ =−5.5×α₁−2.91×α₂+48.4×α₃+C₄×α₄+···Cₙ×αₙ (CC)

α₁+α₂+α₃+α₄+···+αₙ=100 (DD)

In a case in which both of the inherent birefringence and the photoelastic coefficient of the adding component are positive, there is exerted an analogical effect as that of BzMA which has a similar characteristic, so that it is also possible to reduce the BzMA composition up to zero at the maximum. Monomers which can be used are various kinds of methacrylates represented by such as trifluoroethyl methacrylate, phenyl methacrylate or the like, various kinds of acrylates represented by such as methyl-acrylate, butylacrylate or the like, various kinds of styrene-based monomers represented by such as styrene, chlorostyrene or the like, various kinds of maleimide-based monomers such as cyclohexylmaleimide or the like, and the like. Other than those, it is possible to be used if it is a copolymerizable monomer with MMA, tBMA and BzMA. In case of carrying out the manufacture by cast polymerization or the like, it is also possible to use a cross-linking agent.

With regard to other components, it is allowed to add a polymer and a low molecular weight organic compound. It is allowed for these components to be mixed with the aforesaid copolymer in a state of solution or to be melt and kneaded therewith.

Similarly, it is allowed to add a little amount of additive for adjusting the birefringence with respect to a copolymer having a composition which satisfies the aforementioned condition. In a case in which the weight of MMA, tBMA and BzMA which is adjusted so as to satisfy the aforementioned condition is made to be 100, it is desirable for the additive to be less than 10, it is more desirable to be less than 5 and it is still more desirable to be less than 3. It is allowed for the additive to be formed by one kind of additive or to be formed by combining plural kinds of additives.

For the additive for adjusting the birefringence, it is possible to utilize a low molecular weight organic compound which has an approximately stick-shaped molecular shape such as trans-stilbene, fluorene or the like and whose polarizability in the long axis direction of the molecule has a comparatively large difference with respect to that in the short axis direction thereof.

The low-birefringence optical resin material provided by this exemplified embodiment is preferable for an optical film such as a low-birefringence film or the like, which is a member of a liquid crystal display; for an optical member such as a lens or the like, in which low birefringence is required; and the like.

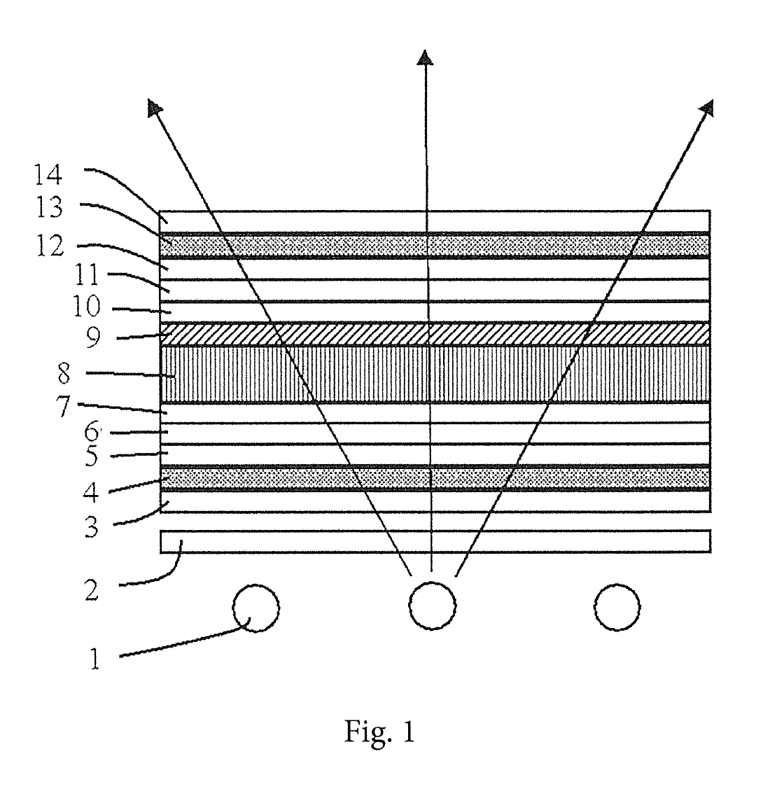

FIG. 1 is a drawing showing a constitution of a general liquid crystal display. In the past, for a light source of a backlight unit, there was mostly utilized a light source using a cold-cathode tube, but recently, the light source using LEDs has been spreading rapidly. Those portions from the light source of the backlight unit to the diffuser in the drawing are usually referred to as a backlight unit and in the drawing, there are omitted some members such as a reflective sheet and the like. There exists also a constitution in which some other members such as a prism sheet and the like are added to the backlight unit. Depending on the use-application of the liquid crystal display, there exists a constitution using optical compensation films (6, 11) or a constitution not using them, in which the number of the used sheets of the optical compensation films is not necessarily limited to the number shown in the drawing either. In addition, there also exists a constitution in which there is omitted the polarizer protective films which are adjacent to the optical compensation films. The optical compensation film is referred to also as a phase-difference film.

It is generally requested for the polarizer protective film, which is an optical film used for the liquid crystal display, to have a low birefringence. Further, there sometimes happens that a stress is to be applied to the film caused by temperature/humidity change or the like during the usage of the display and therefore, it is desirable for the birefringence, which is generated at the time of the elastic deformation in a glassy state (in a state of glass-transition temperature or less), to be smaller.

Therefore, for the low-birefringence optical resin material provided by this exemplified embodiment, applications in particular to the polarizer protective film and the like are expected. Generally, with regard to the polymer film, the mechanical characteristic thereof (rupture strength, bending strength or the like) is improved by carrying out the drawing treatment and by orienting the polymer molecular chain, but usually, it becomes a situation in which the birefringence occurs by being oriented, so that it was difficult to carry out the orientation to such a degree of improving the mechanical characteristic. However, in the low-birefringence optical resin material provided by this exemplified embodiment, the birefringence scarcely occurs even if polymer molecular chain is oriented, so that it is possible to obtain a low-birefringence polymer film, which is excellent also in the mechanical characteristic, by applying the drawing.

Also, in case of manufacturing the optical film by using the low-birefringence optical resin material provided by this exemplified embodiment, it is preferable to add an ultraviolet absorber if necessary. In particular, in case of manufacturing the polarizer protective film used for the liquid crystal display, by compatibly-blending the ultraviolet absorber into the resin, it is possible to improve durability of the resin itself and concurrently, it is possible to expect the improvement in the property of the ultraviolet resistance of the polarizer.

There is no limitation in particular for the structure of the ultraviolet absorber, but it is preferable for the ultraviolet absorber to be used in a state of being compatibly-blended in the resin. For example, it is allowed to use an oxybenzophenone-based compound, a benzotriazole-based compound, a salicylic acid ester-based compound, a benzophenone-based compound, a cyanoacrylate-based compound and a triazine-based compound or to use a dimer/multimer organic ultraviolet absorber of those compounds and a high molecular type ultraviolet absorber. In addition, there can be cited a nickel complex salt-based compound, an inorganic powder or the like.

Also, recently, there has been proposed a polarization-laser plane light-source apparatus which uses a polarized laser. This apparatus employs such a constitution in which the laser light is to be converted to the plane light source by a low-birefringence light-guide plate. Therefore, it is necessary for the light-guide plate to have low birefringence so as not to disturb the polarization state thereof. This is also preferable for such a material of a light-guide plate. For the use-application of this polarization-laser plane light-source apparatus, the backlight of the liquid crystal display is the most suitable, but it is not limited by this application and the apparatus is suitable for the use-application such as for a the projector or the like for which the plane light-source apparatus of the polarized light is utilizable.

This is an optical resin material which is preferable also for various kinds of lenses, such as a pickup lens, a F-⊖ lens, a fresnel lens and a lenticular lens, in which the low birefringence is desirable. In addition, this is preferable also for an optical element which has a minute prism shape such as a prism sheet or the like and which has a function of angle conversion of the incident light or the like.

Also, in a projection type display, there exists a system in which images for the right eye and for the left eye are projected by different polarized lights respectively in order to obtain a three-dimensional image display. In this system, if it becomes a situation in which the polarization state is disturbed on the screen for displaying the image, it causes a result of damaging the image quality significantly and therefore, the low-birefringence screen is desirable. Therefore, the low-birefringence optical material provided by this exemplified embodiment is preferable as raw materials of screens of a rear-projection type display and a front-projection type display. In order to manufacture the screens above by using the low-birefringence optical material, which this exemplified embodiment provides, as a raw material, it is arbitrarily allowed to employ formation of a microscopic minute shape such as of a lenticular lens on the surface thereof; addition of minute particle (for example, particle (having particle diameter of the order from submicron to micron) which has different refractive-index from that of the low-birefringence optical material) for controlling the diffusibility of the incident light; addition of a coloring agent such as dye, pigment, carbon for controlling the contrast; non-reflective coating; anti-glare treatment; hard coating; or the like, and also, it is allowed to employ a combination of a plurality of those above.

In addition to those above, it is preferable to use this material as a material of an optical element/component which is disposed in an optical path of an instrument such as a polarimeter, a polarizing microscope or the like, which utilizes the polarized light, and also, as a material of a container such as of a petri dish which holds a sample to be evaluated or the like and which is used by being disposed in an optical path of these instruments. In particular, with respect to a component which is used for a window portion of a polarimeter or the like, a stress occurs caused by the temperature/humidity change and the birefringence will be generated easily, so that it is preferable to employ the low-birefringence optical material which is provided by this exemplified embodiment.

As mentioned above, this exemplified embodiment provides a low-birefringence optical resin material or the like which is preferably used for an optical member such as an optical film, a lens or the like which is a liquid crystal display member and in which the low-birefringence is required.

There is no limitation in particular for the manufacturing method of the abovementioned optical member using a low-birefringence optical resin provided by this exemplified embodiment, and it is possible to obtain the molding by using an injection-molding method, a vacuum forming method, an extrusion method, a compression molding method or the like, which is a conventional process. In particular, the injection-molding method which is a typical molding method of the thermoplastic resin is a method of carrying out the cooling and the solidification by injecting a melted and heated resin into a die in a state of high pressure, and if there is used a general material, the photoelastic-birefringence occurs easily, but in case of using a low-birefringence optical resin provided by this exemplified embodiment, the birefringence is scarcely generated, so that it is possible to carry out the cooling and the solidification and to carry out the taking-out of the molded product at a higher speed.

For a film-forming method of an optical film, which uses a low-birefringence optical resin provided by this exemplified embodiment, it is possible to use a manufacturing method such as an inflation method, a T-dye method, a calendar method, a cutting method, a casting method, an emulsion method, a hot-press method and the like, in which in case of manufacturing an optical film which is used, in particular, for a liquid crystal display or the like and for which high smoothness is requested, a casting method such as a solution casting film-forming method, a melt casting film-forming method or the like is to be used preferably.

Generally, many of the optical films for the liquid crystal displays are manufactured by the solution casting film-forming method. In this method, the film is manufactured by dissolving the polymer into an organic solvent, by exposing the obtained polymer solution on a smooth base-board and by drying & removing the organic solvent. In the solution casting film-forming method, it is difficult for the polymer molecular chain to be oriented, and it is possible to obtain a low-birefringence polymer film. In addition, it is possible to carry out the manufacture under a comparatively low temperature and by a low viscosity, so that it is possible to obtain high smoothness and concurrently, the solution casting film-forming method is preferably used from a view point of color repression, defect repression of alien substance, repression of optical defect such as dye line, and the like. On the other hand, from the reasons caused by the facts that a large amount of organic solvent is used, that a large-scaled facility is required so as not to leak the steam of the organic solvent toward the outside and that the investment to the facility becomes expensive, or the like, in recent years, the manufacturing of the film by the melt extrusion method has been tried. While it is successful for some of the optical films of the liquid crystal displays in the industrial manufacturing by the melt extrusion method, the polymer molecule will be oriented easily in the molding process and the orientational-birefringence will occur easily, and therefore, it is difficult to heighten the manufacturing speed.

In case of using a low-birefringence optical resin provided by this exemplified embodiment, the birefringence is scarcely generated even if the polymer molecular chain is oriented, so that it is possible, depending on the a higher speed melt extrusion method, to produce the low-birefringence optical film. In addition, the birefringence is scarcely generated also at the time of the elastic deformation in a glassy state, and therefore, this case is ideal. In addition, in any case, when manufacturing the optical film, the orientational-birefringence will easily occur owing to the orientation of the resin material caused by the fact that a drawing process is carried out for obtaining an optical film having wide width and for adjusting various kinds of physical properties, but in case of using a low-birefringence optical resin provided by this exemplified embodiment, the birefringence is scarcely generated, so that it is possible to manufacture an optical film having wide width without damaging the low birefringence property.

Hereinafter, there will be described in detail a preferable condition in case of film-forming an optical film by using a low-birefringence optical resin provided by this exemplified embodiment according to a solution casting film-forming method which is used generally for a manufacturing method of an optical film of a liquid crystal display.

With regard to a preferable solvent in case of being manufactured by the solution casting film-forming method by using a low-birefringence optical resin provided by this exemplified embodiment, there can be cited, as a chlorinated organic solvent, dichloromethane; and there can be cited, as a non-chlorinated organic solvent, methyl acetate, ethyl acetate, amyl acetate, acetone, tetrahydrofuran, 1,3-dioxolane, 1,4-dioxane, cyclohexanone, ethyl methanoate, 2,2,2-trifluoroethanol, 2,2,3,3-hexafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, nitroethane or the like, in which it is possible to preferably use dichloromethane, methyl acetate, ethyl acetate e and acetone.

In addition, other than the above-mentioned organic solvents, it is preferable to contain 1 wt % to 40 wt % fatty-alcohol of 1 to 4 carbon-atoms having a straight-chain or branched-chain shape. When the ratio of the alcohol in a dope (solution in which resin is dissolved) becomes high, the web is gelatinized and the peeling from the metal support becomes easy, and in addition, when the ratio of the alcohol is small, there is also a role of accelerating the dissolution of the resin in the non-chlorine-based organic solvent system.

Hereinafter, there will be explained respective processes of a solution casting film-forming method.

1) Dissolution Process

This is a process for forming a dope in which into an organic solvent including an excellent solvent with respect to the low-birefringence optical resin provided by this exemplified embodiment as a main solvent, aforesaid resin, in some cases, together with another additive is dissolved while being stirred, or this is a process for forming a dope, which is the main dissolution liquid, by mixing another additive solution with the aforesaid resin.

For the dissolution of the resin, it is possible to use various kinds of dissolution methods such as a method for carrying out the dissolution at the room pressure, a method for carrying out the dissolution at the boiling temperature or less of the main solvent, a method for carrying out the dissolution by being pressurized at a boiling temperature or more of the main solvent, a method for carrying out the dissolution by a cooling dissolution method such as described in Japanese unexamined patent publication No. H9-95544, Japanese unexamined patent publication No. H9-95557 or Japanese unexamined patent publication No. H9-95538, a method for carrying out the dissolution under a high pressure such as described in Japanese unexamined patent publication No. H11-21379, and the like, in which it is preferable, in particular, to employ a method for carry out the dissolution by being pressurized at the boiling temperature or more of the main solvent.

It is preferable for the resin in the dope to be in a range of total 15 wt % to 45 wt %. After adding and dispersing an addition agent into the dope during or after the dissolution thereof, the dope is filtrated by a filter medium, is degassed and is transferred to a next process by a liquid feeding pump.

It is preferable for the filtration to use a filter medium whose collected particle diameter is 0.5 μm to 5 μm, and also, whose filtering

In this method, it is possible to remove only aggregates by using a filter medium whose collected particle diameter is 0.5 μm to 5 μm, and also, whose filtering time is 10 sec/100 ml to 25 sec/100 ml with respect to the aggregates which remain when dispersing the particle and with respect to the aggregates which are generated when adding the main dope. In the main dope, the concentration of the particle is sufficiently dilute compared with that of the addition liquid, so that rapid rising of the filter pressure never happens caused by a phenomenon in which the aggregates stick to each other during the filtration.

2) Casting Process

This is a process in which the dope is fed in a liquid manner to a pressure dye by way of a liquid feeding pump (for example, pressure type metering gear pump) and the dope is casted from a pressure dye slit to the casting position on an endless mirror-surface metal belt for the infinite transport or on a metal support of, for example, a stainless belt, a rotating mirror-surface metal drum or the like.

It is preferable to provide a pressure dye in which the slit shape at the metal mouthpiece portion of the dye can be adjusted and in which it is easy for the film thickness to be made uniformly. Among the pressure dyes, there exist a coat hanger dye, a T dye and the like, in which any one of them is used preferably. The surface of the metal support is formed as a mirror surface. In order to raise the film-forming speed, it is allowed to provide two pieces or more of pressure dyes on the metal support and to form multilayers by dividing the amount of dopes. Alternatively, it is also preferable to obtain a film having a laminated structure by using a co-casting method of casting a plurality of dopes simultaneously.

3) Solvent Evaporation Process

This is a process in which a web (dope film which is formed by casting a dope on a support for casting is referred to as web) is heated on the support for casting and the solvent is evaporated.

For evaporating the solvent, there exist a method of blowing air from the web side and/or a method of transferring heat from the rear surface of the support by using liquid, a method of transferring heat from the front and back by using radiant heat, and the like, in which the heat transferring method by liquid from the rear surface has an excellent drying efficiency and is preferable. In addition, there is preferably used also a method which is formed by combining the methods above. It is preferable to dry the web on the support after the casting under an atmosphere of 40° C. to 100° C. In order to maintain the condition under the atmosphere of 40° C. to 100° C., it is preferable to blow hot air of this temperature onto the upper surface of the web or to carry out the heating by means of infrared rays or the like.

From viewpoints of surface quality, moisture permeability and peeling property, it is preferable to peel the aforesaid web from the support within 30 sec to 120 sec.

4) Peeling Process

This is a process of peeling a web, whose solvent is evaporated on the metal support, at the peeling position. The peeled web is transferred to a next process.

The temperature at the peeling position on the metal support is preferably 10° C. to 40° C. and more preferably, 11° C. to 30° C.

It should be noted that it is preferable to peel the amount of residual solvents when peeling the web on the metal support at the time of the peeling in a range of 50 wt % to 120 wt % depending on the strength and weakness of the drying condition, the length of the metal support or the like, in which in case of carrying out the peeling at the time when the amount of residual solvents exists more, flatness at the time of peeling is impaired if the web is too soft and it is easy for tangles or vertical lines to occur caused by the peeling tension, so that the amount of residual solvents at the time of peeling is determined according to the balance between the economical speed and the quality.

The amount of residual solvents of the web is defined by the following equation.

Amount of residual solvents(wt %)=(weight of web before heat-treatment−weight of web after heat-treatment)/(weight of web after heat-treatment)×100

It should be noted that “heat-treatment at the time of measuring the amount of residual solvents” means that “heat-treatment of 1 hour at 115° C. is carried out”.

The peeling tension when peeling the film from the metal support is usually 196N/m to 245N/m, but in a case in which wrinkles are easily inserted on an occasion of the peeling, it is preferable to carry out the peeling by a tension of 190N/m or less and further, it is preferable to carry out the peeling by a tension between the lowest tension, by which the peeling can be attained, and 166.6N/m and subsequently, by a tension between the lowest tension and 137.2N/m, in which it is especially preferable to carry out the peeling by a tension between the lowest tension and 100N/m.

It is preferable to set the temperature at the peeling position on the aforesaid metal support to be −50° C. to 40° C., it is more preferable to set it to be 10° C. to 40° C. and it is the most preferable to set it to be 15° C. to 30° C.

5) Drying and Drawing Process

After the peeling, the web is dried by using a drying apparatus which conveys the web by alternately passing the web through the rolls which are arranged by a plurality of rolls in the drying apparatus and/or by using a tenter drawing apparatus which conveys the web by clipping both the ends thereof by clips.

It is general for the drying means to blow heated air onto both the surfaces of the web, but there also exists means for heating the web by applying microwave instead of the air. An excessively rapid drying will easily diminish the flatness of the completed film. It is desirable for the drying under a high temperature to be carried out from a condition in which the residual solvent is 8 wt % or less. Throughout the whole procedure, the drying is carried out basically at 40° C. to 250° C. In particular, it is preferable to carry out the drying by 40° C. to 160° C.

In case of using a tenter drawing apparatus, it is preferable to use an apparatus in which the grasping length (distance from the grasp-start to the grasp-end) can be controlled independently at the right and left sides by the right and left grasping means of the tenter. In addition, it is also preferable, in the tenter process, to create compartments having different temperatures intentionally in order to improve the flatness.

In addition, it is also preferable to provide a neutral zone between the compartments having different temperatures such that the respective compartments do not cause interference with each other.

It should be noted that it is allowed for the drawing operation to be implemented by being divided into multi-steps, and it is also preferable to implement biaxial drawing toward a casting direction and a width direction. Also, in case of carry out the biaxial drawing, it is allowed to carry out simultaneous biaxial drawing and it is allowed to implement the drawing in a stepwise fashion.

In this case, with regard to the stepwise fashion, for example, it is also possible to carry out the drawing having different extending directions in sequence and it is also possible to divide the drawing in the same direction into multi-steps of drawing and concurrently, to add a drawing in a different direction with respect to any one of the steps thereof. More specifically, it is possible, for example, to employ drawing steps such as follows.
drawing toward the casting direction—drawing toward the width direction—drawing toward the casting direction—drawing toward the casting direction
drawing toward the width direction—drawing toward the width direction—drawing toward the casting direction—drawing toward the casting direction

Also, in the simultaneous biaxial drawing, there is included also a case in which drawing is carried out in one direction and the other one is contracted by reducing the tension. It is possible to employ a preferable draw ratio of the simultaneous biaxial drawing in a range from ×1.01 times to ×2.5 times for both of the width direction and the longitudinal direction.

It is preferable for the amount of residual solvents of the web, in case of carrying out the tenter, to be 20 wt % to 100 wt % when starting the tenter and also, it is preferable to carry out the drying while applying the tenter until the amount of residual solvents of the web becomes 10 wt % or less, more preferably, 5 wt % or less.

It is preferable for the drying temperature in case of carrying out the tenter to be 30° C. to 160° C., more preferably to be 50° C. to 150° C., and most preferably to be 70° C. to 140° C.

In the tenter process, it is preferable for the temperature distribution of the width direction in the atmosphere to be low from a viewpoint of heightening the uniformity of the film, and it is preferable for the temperature distribution of the width direction in the tenter process to be within ±5° C., more preferably within ±2° C. and most preferably within ±1° C.

6) Winding Process

This is a winding process of winding the web as an optical film by a winding machine after the amount of residual solvents in the web becomes 2 wt % or less and by setting the amount of residual solvents to be 0.4 wt % or less, it is possible to obtain a film excellent in size-stability. In particular, it is preferable to wind the film by 0.00 wt % to 0.10 wt %.

With regard to the winding method, it is enough if using a method which has been used generally, in which there exist a constant torque method, a constant tension method, a tapered tension method, a programmed tension control method having constant internal stress, and the like, and it is enough if they are used properly.

It is preferable for the optical film, which is obtained by using the low-birefringence optical resin which this exemplified embodiment provides, to be a long sized film, in which specifically, the film presents a length of around 10 m to 5000 m and usually, has a shape provided in a roll shape. Also, it is preferable for the width of the film to be 1.3 m to 4 m and it is more preferable to be 1.4 m to 2 m.

There is no limitation in particular for the film thickness of the optical film obtained by using the low-birefringence optical resin which this exemplified embodiment provides, but in case of using the film for a polarizer protective film in a liquid crystal display, it is preferable for the thickness to be 20 μm to 200 μm, it is more preferable to be 25 μm to 100 μm and it is especially preferable to be 30 μm to 80 μm.

### Inventive Example

As described hereinafter, a binary system copolymer is synthesized and the evaluation thereof was carried out. First, into a glass made sample tube, there were inputted total 30 g of methyl methacrylate (MMA) (Mitsubishi Gas Chemical Company Inc.) and benzyl methacrylate (BzMA) (Tokyo Chemical Industry Co., Ltd.); 0.4 wt % of perbutyl O (perbutyl is a registered trademark) (t-butyl peroxy-2-ethylhexanoate) (Nippon Oil & Fats Co., Ltd.) with respect to a monomer; and 0.1 wt % of n-butylmercaptan (Wako Pure Chemical Industries, Ltd.) with respect to a monomer. With regard to the ratio (weight ratio) of the monomer, there were adjusted the ratios of MMA/BzMA=100/0, 80/20, 60/40, 40/60, 20/80, 0/100 respectively. After those are stirred, dissolved and uniformed sufficiently, they are filtrated through a membrane filter and the monomers with regard to the respective monomer ratios are transferred to two pieces of test tubes respectively. These test tubes are placed in a water bath of 70° C. and the polymerization was carried out for 24 hours. Subsequently, the heat-treatment was carried out for 24 hours in a dryer of 90° C. The ratios of the respective components in the obtained copolymer were found by a nuclear magnetic resonance spectrometry method (NMR).

With respect to the obtained cylinder-shaped polymer, one of the cylinder both end surfaces was polished. A load is applied to this cylinder-shaped polymer from the side surface and by using an automatic birefringence measuring apparatus ABR-10A (Uniopt Corporation, Ltd.), a laser light is made to enter along a cylindrical axis thereof and the photoelastic-birefringence was measured (measurement-wavelength 633 nm). Further, the photoelastic coefficient C of the copolymer of each composition ratio was found from the measurement result. There exists a linear relation between the photoelastic coefficient C and the copolymer composition, so that a graph of “photoelastic coefficient C” vs “composition (wt %) of MMA in copolymer” is created and an approximate straight line was found, and by extrapolating this to “composition (wt %) of MMA”=0, the photoelastic coefficient CPBzMA=48.4 [TPa−1] of poly(benzyl methacrylate)(PBzMA) was obtained. In addition, it is possible for the photoelastic coefficient of PMMA to be found directly from a PMMA sample which is a homopolymer and the photoelastic coefficient C_{PMMA}=−5.5[TPa⁻¹] was obtained.

The other polymer is inputted into a glass made sample tube together with dichloromethane (Wako Pure Chemical Industries, Ltd.) having five-time amount by the weight ratio and this was stirred and dissolved sufficiently. The obtained polymer solution was exposed in a glass plate-shape with the thickness of approximately 0.2 mm by using a knife coater, and this was left at the room temperature for one day and was dried. The film was peeled from the glass plate and was dried further for 48 hours in a vacuum dryer of 60° C. The obtained film having thickness of approximately 40 mm was processed to have a dumbbell-shape and a uniaxial drawing was applied thereto by a tensilon universal testing machine (manufactured by Orientec Co., LTD). At that time, by applying the drawing by using some of the drawing temperatures, drawing speeds and draw ratios, there was produced an uniaxial drawn film whose degree of orientation is within the range of around 0.00 to 0.08. The birefringence of the film after the drawing was measured by using an automatic birefringence measuring apparatus ABR-10A (Uniopt Corporation, Ltd.) (measurement-wavelength 633 nm). The degree of orientation of the film after the drawing was measured by a two-color infrared absorption method.

The relation among the orientational-birefringence Δn, the degree of orientation f (of polymer main-chain) and the inherent birefringence Δn⁰ can be expressed by an equation as follows.

Δn=f×Δn⁰ (A)

Therefore, by creating a graph of the “orientational-birefringence” vs “degree of orientation” from the measurement values in the aforementioned respective copolymer compositions, it is possible to find the inherent birefringence Δn0 of the copolymer of each composition from the inclination of the approximation straight line. Further, there exists a linear relation between the inherent birefringence Δn0 and the copolymer composition, so that by creating a graph of the “inherent birefringence” vs “composition (wt %) of MMA”, by finding an approximation straight line and by extrapolating this into the “composition of MMA in copolymer (wt %)”=0, there was obtained the inherent birefringence of PBzMA Δn0PBzMA=19.5×10−3. Also, it is possible to find the inherent birefringence of PMMA directly from an uniaxial drawing sample of PMMA which is a homopolymer, and there was obtained the inherent birefringence Δn⁰_{PMMA}=−5.6×10⁻³.

With regard also to the tert-butyl methacrylate (tBMA) (Tokyo Chemical Industry Co., Ltd.) and the binary system copolymer of MMA, there were carried out experiments similar to that mentioned above. As a result thereof, there were obtained the photoelastic coefficient C_{PtBMA}=−2.91 [TPa⁻¹] and the inherent birefringence Δn⁰_{PtBMA}=1.45×10⁻³ for the poly(tert-butyl methacrylate)(PtBMA).

From the inherent birefringences Δn0PMMA, Δn0PtBMA, Δn0PBzMA and the photoelastic coefficients CPMMA, CPtBMA, CPBzMA with regard to the respective homopolymers mentioned above, the inherent birefringence Δn0 [×10⁻³] and the photoelastic coefficient C [TPa⁻¹] for the ternary system copolymer poly(MMA/tBMA/BzMA) are expressed by the following equations.

$$\begin{matrix}\begin{matrix}Δ {n}^{0} = Δ {n}_{PMMA}^{0} \times α + Δ {n}_{PtBMA}^{0} \times β + Δ {n}_{PBzMA}^{0} \times γ \\ = - 5.6 \times α + 1.45 \times β + 19.5 \times γ\end{matrix} & ( B ) \\ \begin{matrix}C = {C}_{PMMA} \times α + {C}_{PtBMA} \times β + {C}_{PBzMA} \times γ \\ = - 5.5 \times α - 2.97 \times β + 48.4 \times γ\end{matrix} & ( C ) \\ α + β + γ = 100 & ( D )\end{matrix}$$

Here, α, β, γ are weight ratios (%) for MMA component, tBMA component and BzMA component respectively in a copolymer. By solving the equations (B) to (D) simultaneously under the condition of Δn0=C=0, there was found a composition whose orientational-birefringence and photoelastic-birefringence are expected to become zero. As a result thereof, there were obtained α=40 (wt %), β=52 (wt %), γ=8 (wt %).

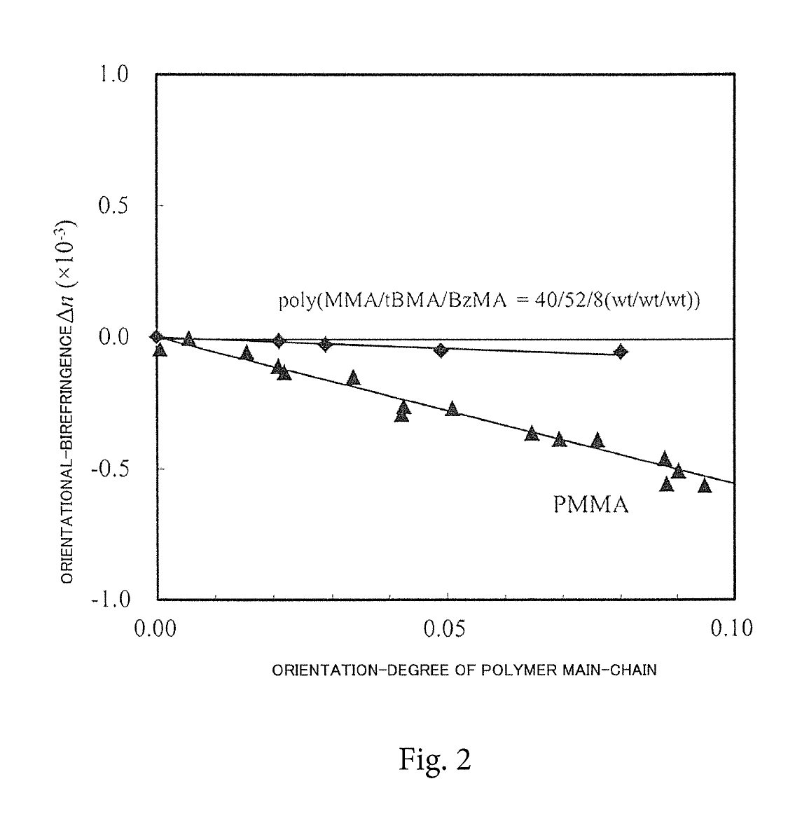

The results obtained by actually synthesizing a copolymer poly(MMA/tBMA/BzMA=40/52/8(wt/wt/wt)) having this composition and by measuring the orientational-birefringence and the photoelastic-birefringence are shown by using a graph and a table respectively. FIG. 2 is a chart showing orientational-birefringence vs orientation-degree of polymer main-chain of a copolymer poly(MMA/tBMA/BzMA=40/52/8(wt/wt/wt)). Table 1 is a table showing the photoelastic coefficient of the copolymer poly(MMA/tBMA/BzMA=40/52/8(wt/wt/wt)).

From those above, it was possible to confirm that the orientational-birefringence and the photoelastic-birefringence are approximately zero.

TABLE 1

| | Photoelastic coefficient |
|---|---|
| Polymer | [Tpa⁻¹] |
| Poly(MMA/tBMA/BzMA = 40/52/8(wt/wt/wt)) | 0.0 |
| PMMA | −5.5 |

When the glass-transition temperature of the synthesized poly(MMA/tBMA/BzMA=40/52/8(wt/wt/wt)) was measured by Differential Scanning calorimeters (Shimadzu Corporation, DSC-60), the temperature was approximately 120° C.

The copolymer poly(MMA/tBMA/BzMA=40/52/8(wt/wt/wt)) having a composition, in which it became clear by the aforementioned design that the orientational-birefringence and the photoelastic-birefringence are scarcely generated, was synthesized by a radical polymerization (A-1). The dope solution was adjusted by mixing the obtained copolymer and solvents as shown as follows.

(Adjustment of Dope Solution)
A-1: 100 pts.wt.
Methylene chloride: 252 pts.wt.
Ethanol: 48 pts.wt.

(Film-Forming of Optical Film)

The produced dope solution mentioned above was casted uniformly onto the stainless band support under the temperature of 22° C. by using a belt casting apparatus. The solvent was evaporated on the stainless band support until the amount of residual solvents becomes 100 wt %, this was peeled from the top of the stainless band support by the peeling tension 162N/m.

With regard to the peeled web, the solvent thereof was evaporated at 35° C. and both the ends thereof were slit and thereafter, the web was dried at the drying temperature of 135° C. while being drawn to 1.5 times thereof by the tenter in the width direction (referred to also as lateral direction).

At that time, the amount of residual solvents when beginning the drawing by the tenter was 10%. The relaxation was carried out for 5 minutes under 130° C. after being drawn by the tenter and thereafter, the drying was finished while conveying the web by a large number of rolls in the drying zones of 120° C., 130° C. and further, both the ends thereof were slit and a knurling process of the width 10 mm and the height 5 μm was applied to both the ends of the film, the web was wound around a core having an inner diameter of 6 inch by an initial tension of 220N/m and a final tension of 110N/m, and there was obtained an optical film. It should be noted that the draw ratio in the long-length direction (referred to also as vertical direction) which is calculated from the rotation speed of the stainless band support and the driving speed of the tenter was 1.5 times. The amount of residual solvents of the obtained optical film F-1 was 0.1 wt % and the film thickness was 40 μm.

With regard to the obtained optical film, the polymer molecules thereof are oriented by being drawn and the strength with respect to the bending was improved. In addition, the inherent birefringence of the copolymer is very small, so that also after the drawing, there was maintained the low birefringence property which is desirable for the use-application of the polarizer protective film of the liquid crystal display.

Two sheets of glass plates are overlapped and a fluoro-rubber made tube was disposed therebetween in a “square” shape so as to go along the four sides of the glass plates, in which the four sides of the glass plates are fixed by being pinched by clips. The outer diameter of the tube is approximately 3.0 mmφ and caused by a phenomenon that this tube is deformed by the force of the clips and reduces the gaps, there can be obtained a space of approximately 2.5 mm (a die for cast polymerization) between two sheets of the glass plate. A mixed monomer solution of MMA/tBMA/BzMA=40/52/8(wt/wt/wt) is poured into this space. Into this solution, as the initiator, there are added 0.4 mol % of di-tert-butyl peroxide (NOF Corporation) and 0.125 mol % of n-butyl mercaptan (Wako Pure Chemical Industries, Ltd.) with respect to the monomer. This was polymerized for 24 hours in a constant-temperature bath of 90° C. and thereafter, the temperature was raised to 110° C. and the polymerization was carried out for another 24 hours. The birefringence of the plate shaped sample (thickness t=approximately 2.5 mm) of the obtained copolymer was 0.5 nm or less at the retardation (=ΔnΔt). Also, the water-absorbing property was approximately around half compared with that of PMMA.

As described above, there has been explained the present invention while referring to specific exemplified embodiments. However, it is obvious that modifications or substitutions of the exemplified embodiments can be employed by a person skilled in the art without departing the scope of the gist of the present invention. More specifically, the present invention has been disclosed by the mode such as illustration, the described contents of this description should not be interpreted limitedly. In order to evaluate the gist of the present invention, the “CLAIMS” column described at the beginning should be taken into consideration.

In addition, it is clear that the exemplified embodiments for the explanation of the present invention will achieve the above-mentioned objects and it is also to be understood that it is possible for a person skilled in the art to employ many changes and other inventive examples. It is allowed to employ an element or a component of each exemplified embodiment for the scope of claims, the specification, the drawings and the explanation together with another one or a combination thereof. The scope of claims are intended to include also such changes and other exemplified embodiments in the scope thereof and those above shall be included in the technical idea and the technical scope of the present invention.

### INDUSTRIAL APPLICABILITY

The present invention is applicable to an optical resin material or the like which is excellent in heat resistance.

1. An optical resin material including a multicomponent system whose number of components z which is defined under a counting condition of including original number x(x≧2) of copolymer into the number of components is three or more, wherein
said multicomponent system is constituted only by a copolymer whose original number x is three or more, or is constituted by a copolymer whose original number x is two or more and by at least one kind of low-molecular-weight organic compound which has polarizability anisotropy and which can be oriented in polymer;
the combination of the components constituting said multicomponent system is selected such that:
at least one of respective signs of intrinsic orientational-birefringences of respective homopolymers which correspond to respective monomers constituting respective components of said copolymer and signs of orientational-birefringence properties which said low-molecular-weight organic compound presents in common in said respective homopolymers has a different sign from those of others, and also,
at least one of photoelastic-birefringence properties of said respective homopolymers and photoelastic-birefringence properties which said low-molecular-weight organic compound presents in common in said respective homopolymers has a different sign from those of others;
component ratio of the components constituting said multicomponent system is selected such that the orientational-birefringence and the photoelastic-birefringence which said non-birefringent optical resin presents will be canceled simultaneously by utilizing different-sign relation relating to said orientational-birefringence property and different-sign relation relating to said photoelastic-birefringence property; and
at least one of the monomers constituting the components of said copolymer is tert-butyl methacrylate.

2. An optical resin material including a multicomponent system whose number of components z which is defined under a counting condition of including original number x(x≧2) of copolymer into the number of components is three or more, wherein
said multicomponent system is constituted only by a copolymer whose original number x is three or more, or is constituted by a copolymer whose original number x is two or more and by at least one kind of low-molecular-weight organic compound which has polarizability anisotropy and which can be oriented in polymer;
the combination of the components constituting said multicomponent system is selected such that:
at least one of respective signs of intrinsic orientational-birefringences of respective homopolymers which correspond to respective monomers constituting respective components of said copolymer and signs of orientational-birefringence properties which said low-molecular-weight organic compound presents in common in said respective homopolymers has a different sign from those of others, and also,
at least one of photoelastic-birefringence properties of said respective homopolymers and photoelastic-birefringence properties which said low-molecular-weight organic compound presents in common in said respective homopolymers has a different sign from those of others;
component ratio of the components constituting said multicomponent system is selected such that the orientational-birefringence and the photoelastic-birefringence which said non-birefringent optical resin presents will be canceled simultaneously by utilizing different-sign relation relating to said orientational-birefringence property and different-sign relation relating to said photoelastic-birefringence property; and
at least two of the monomers constituting the components of said copolymer are methyl methacrylate and tert-butyl methacrylate.

3. An optical resin material including a multicomponent system whose number of components z which is defined under a counting condition of including original number x(x≧2) of copolymer into the number of components is three or more, wherein
said multicomponent system is constituted only by a copolymer whose original number x is three or more, or is constituted by a copolymer whose original number x is two or more and by at least one kind of low-molecular-weight organic compound which has polarizability anisotropy and which can be oriented in polymer;
the combination of the components constituting said multicomponent system is selected such that:
at least one of respective signs of intrinsic orientational-birefringences of respective homopolymers which correspond to respective monomers constituting respective components of said copolymer and signs of orientational-birefringence properties which said low-molecular-weight organic compound presents in common in said respective homopolymers has a different sign from those of others, and also,
at least one of photoelastic-birefringence properties of said respective homopolymers and photoelastic-birefringence properties which said low-molecular-weight organic compound presents in common in said respective homopolymers has a different sign from those of others;
component ratio of the components constituting said multicomponent system is selected such that the orientational-birefringence and the photoelastic-birefringence which said non-birefringent optical resin presents will be canceled simultaneously by utilizing different-sign relation relating to said orientational-birefringence property and different-sign relation relating to said photoelastic-birefringence property; and
at least three of the monomers constituting the components of said copolymer are methyl methacrylate, tert-butyl methacrylate and benzyl methacrylate.

4. The optical resin material according to claim 3, wherein the inherent birefringence is within the range of −3.0×10⁻³ or more and 2.4×10⁻³ or less; the photoelastic coefficient is within the range of −3.3 [TPa⁻¹] or more and 5.0 [TPa⁻¹] or less; and the following simultaneous equations (B) to (D) are satisfied in which there exists a composition for each component that becomes positive (solution of the simultaneous equations):
Δn⁰=Δn⁰_{PMMA}×α+Δn⁰_{PtBMA}×β+Δn⁰_{PBzMA×γ}=−5.6×α+1.45×β+19.5×γ (B)
C=C_{PMMA}×α+C_{PtBMA}×β+C_{PBzMA}×γ=−5.5×α−2.97×β+48.4×γ (C)
α+β+γ=100 (D)
(Here, Δn⁰_{PMMA}, Δn⁰_{PtBMA}, Δn⁰_{PBzMA} and C_{PMMA}, C_{PtBMA}, C_{PBzMA} express inherent birefringences [×10⁻³] and photoelastic coefficients [TPa⁻¹] of PMMA, PtBMA, PBzMA respectively, and α, β, γ express weight ratios (%) of methyl methacrylate component, tert-butyl methacrylate component, benzyl methacrylate component in the copolymer respectively.)

5. The optical resin material according to claim 4, wherein α=40 (wt %), β=52 (wt %) and γ=8 (wt %) are satisfied.

6. The optical resin material according to claim 3, wherein at least one component within the components constituting said multicomponent system is at least one of subcomponent and additive.

7. A manufacturing method of an optical resin material for manufacturing an optical resin material by copolymerization in which said optical resin material is an optical resin material including a multicomponent system whose number of components z which is defined under a counting condition of including original number x(x≧2) of copolymer into the number of components is three or more, wherein
said multicomponent system is constituted only by a copolymer whose original number x is three or more, or is constituted by a copolymer whose original number x is two or more and by at least one kind of low-molecular-weight organic compound which has polarizability anisotropy and which can be oriented in polymer;
the combination of the components constituting said multicomponent system is selected such that:
at least one of respective signs of intrinsic orientational-birefringences of respective homopolymers which correspond to respective monomers constituting respective components of said copolymer and signs of orientational-birefringence properties which said low-molecular-weight organic compound presents in common in said respective homopolymers has a different sign from those of others, and also,
at least one of photoelastic-birefringence properties of said respective homopolymers and photoelastic-birefringence properties which said low-molecular-weight organic compound presents in common in said respective homopolymers has a different sign from those of others;
component ratio of the components constituting said multicomponent system is selected such that the orientational-birefringence and the photoelastic-birefringence which said non-birefringent optical resin presents will be canceled simultaneously by utilizing different-sign relation relating to said orientational-birefringence property and different-sign relation relating to said photoelastic-birefringence property; and
at least one of the monomers constituting the components of said copolymer is tert-butyl methacrylate.

8. A manufacturing method of an optical film for film-forming an optical resin material by a solution casting film-forming method which includes a manufacturing process of an optical resin material for manufacturing an optical resin material by copolymerization in which said optical resin material is an optical resin material including a multicomponent system whose number of components z which is defined under a counting condition of including original number x(x≧2) of copolymer into the number of components is three or more, wherein
said multicomponent system is constituted only by a copolymer whose original number x is three or more, or is constituted by a copolymer whose original number x is two or more and by at least one kind of low-molecular-weight organic compound which has polarizability anisotropy and which can be oriented in polymer;
the combination of the components constituting said multicomponent system is selected such that:
at least one of respective signs of intrinsic orientational-birefringences of respective homopolymers which correspond to respective monomers constituting respective components of said copolymer and signs of orientational-birefringence properties which said low-molecular-weight organic compound presents in common in said respective homopolymers has a different sign from those of others, and also,
at least one of photoelastic-birefringence properties of said respective homopolymers and photoelastic-birefringence properties which said low-molecular-weight organic compound presents in common in said respective homopolymers has a different sign from those of others;
component ratio of the components constituting said multicomponent system is selected such that the orientational-birefringence and the photoelastic-birefringence which said non-birefringent optical resin presents will be canceled simultaneously by utilizing different-sign relation relating to said orientational-birefringence property and different-sign relation relating to said photoelastic-birefringence property; and
at least one of the monomers constituting the components of said copolymer is tert-butyl methacrylate.

9. An optical film for display, which is obtained by molding an optical resin material, wherein said optical resin material is the optical resin material according to claim 1.

10. An optical film for liquid crystal display, which is obtained by molding an optical resin material, wherein said optical resin material is the optical resin material according to claim 1.

11. A polarizer protective film, which is obtained by molding an optical resin material, wherein said optical resin material is the optical resin material according to claim 1.

12. An optical film, which is obtained by molding an optical resin material by a solution casting film-forming method, wherein said optical resin material is the optical resin material according to claim 1.

13. A polarization-plane light-source apparatus, which is obtained by molding an optical resin material, wherein said optical resin material is the optical resin material according to claim 1.

14. A lens, which is obtained by molding an optical resin material, wherein said optical resin material is the optical resin material according to claim 1.

15. A screen whose raw material is an optical resin material, wherein said optical resin material is the optical resin material according to claim 1.

16. An optical element, which is obtained by molding an optical resin material, wherein said optical resin material is the optical resin material according to claim 1.

17. A member dispose in an optical path, which is obtained by molding an optical resin material, wherein said optical resin material is the optical resin material according to claim 1.

18. The optical resin material according to claim 3, wherein the inherent birefringence is within the range of −3.0×10⁻³ or more and 2.4×10⁻³ or less; the photoelastic coefficient is within the range of −3.3 [TPa⁻¹] or more and 5.0 [TPa⁻¹] or less; and the following simultaneous equations (BB) to (DD) are satisfied in which there exists a composition for each component that becomes positive (solution of the simultaneous equations):
Δn⁰=Δn⁰_{PMMA}×α₁+Δn⁰_{PtBMA}×α₂+Δn⁰_{PBzMA}×α₃+Δn⁰₄×α₄+ . . . +Δn⁰ₙ×αₙ=−5.6×α₁+1.45×α₂+19.5×α₃+Δn⁰₄×α₄+ . . . +Δn⁰ₙ×αₙ (BB)
C=C_{PMMA}×α₁+C_{PtBMA}×α₂+C_{PBzMA}×α₃+C₄×α₄+ . . . +Cₙ×αₙ=−5.5×α₁−2.91×α₂+48.4×α₃+C₄×α₄+ . . . +Cₙ×αₙ (CC)
α₁+α₂+α₃+α₄+ . . . +αₙ=100 (DD)
(Here, Δn⁰_{PMMA}, Δn⁰_{PtBMA}, Δn⁰_{PBzMA}, Δn⁰₄, Δn⁰ₙ, C_{PMMA}, C_{PtBMA}, C_{PBzMA}, C₄, Cₙ express inherent birefringences [×10⁻³] and photoelastic coefficients [TPa⁻¹] of PMMA, PtBMA, PBzMA, the fourth component, the n^{th} component respectively, and α₁, α₂, α₃, α₄, αₙ express weight ratios (%) of methyl methacrylate component, tert-butyl methacrylate component, benzyl methacrylate component, the fourth component, the n^{th} component in the copolymer respectively.)
